(19) United States
(12) Patent Application Publication
(10) Pub. No.: US 2025/0296082 A1
(43) Pub. Date: Sep. 25, 2025

(54) METHOD FOR MANUFACTURING A BIOLOGICAL ANALYSIS CARD INVOLVING A HEATING BLOCK

(71) Applicant: bioMérieux, Marcy-l'Étoile (FR)

(72) Inventors: Patrick BROYER, SAINT CASSIEN (FR); Matthieu GOUJARD, GRENOBLE (FR); Frédéric PINSTON, GRENOBLE (FR); Hervé ROSTAING, LE VERSOUD (FR); Jérome BLAZE, LA TERRACE (FR); Pierre IMBAUD, POMMIERS (FR)

(21) Appl. No.: 18/875,891

(22) PCT Filed: Jun. 20, 2023
(86) PCT No.: PCT/FR2023/000118

§ 371 Date: Dec. 17, 2024

(30) Foreign Application Priority Data
Jun. 21, 2022 (FR) FR2206097

(51) Int. Cl. B01L 3/00; B01L 7/00

(52) U.S. Cl. CPC B01L 3/502707; B01L 7/00; B01L 2200/027; B01L 2300/0816; B01L 2300/0829; B01L 2300/0887; B01L 2400/06

(57) ABSTRACT

The invention relates to a method for manufacturing a biological analysis card (1) comprising:—a step a) of providing a base (2) formed of:—at least two films (3) placed one on top of the other;—a receiving space (4) formed between the two films (3); —ducts (5) leading to the receiving space (4);—a step b) of placing a plate (9) in the receiving space (4), the plate (9) comprising:—a first face (10a) and a second face connected by an edge (11) having a profile;—a plurality of wells (12) opening onto at least the first face (10a) or the second face;—a plurality of channels (13) fluidly connecting the wells (12);—a welding step c) for welding the two films (3) in the receiving space (4) to the plate (9) and a film (3) to segments of the edge (11) of the plate (9) by applying a heating block to the film (3) against the edge (11) on the side of the first face (10a).

### CROSS-REFERENCE TO RELATED APPLICATIONS

This application is a 35 U.S.C. § 371 national phase application of International Application Serial No. PCT/FR2023/000118, filed Jun. 20, 2023, which claims priority from French Patent Application No. 2206097, filed Jun. 21, 2022, the contents of which are incorporated herein by reference. The above-referenced PCT International Application was published in the French language as International Publication No. WO 2023/247845 A1 on Dec. 28, 2023.

### FIELD

The present invention relates to the field of biological sample analysis, and more specifically relates to a method for manufacturing an analysis card using a heating block, to the analysis card obtained by the method, and to the heating block used.

### BACKGROUND

In vitro biological analysis of biological samples, such as polymerase chain reaction (PCR) tests, is based on one or more reactions between the biological sample and one or more reagents. A biological sample may include tissues and cells from a human or animal body and their derivatives, organs, blood, its components or derived products. There are microfluidic systems and methods for carrying out these biological sample analyses. The reagents are placed in wells of a plate called an “array” and the biological sample to be analyzed is brought into contact with the reagents by flooding. The plate is assembled to a flexible base that includes biological sample reservoirs and ducts. The ducts in the base are connected to the channels in the plate in such a way as to form fluid pathways. An analysis card, such as the “FilmArray®” analysis card for performing PCR tests, is formed. Assembling this card is a complex procedure that requires bonding at least four layers of film and adhesive layers to the plate before attaching the plate to the base. This involves the use of special machines and a large quantity of consumables (films and adhesive layers), which significantly increases costs and increases the risk of defects in the event of leaks between the layers.

Moreover, with the “FilmArray®” analysis card configuration, only one biological sample reaches the plate via a duct. “FilmArray®” cannot therefore be used for the analysis of several biological solutions, for example the same biological sample at different concentrations, within the same analysis card and therefore for example in the case of endotoxin detection tests. This is because in endotoxin detection tests, the biological sample is diluted to different concentrations and each dilution is analyzed. Therefore, great care must be taken to ensure that the different dilutions of the biological sample do not mix with each other before reaching the reaction wells of the plate so that the reaction results are usable.

Lastly, again taking endotoxin detection tests as an example, one specific aspect that must be pointed out is the thickness of the plate, which is much greater than that of the “FilmArray®”. The detection sensitivity necessary for endotoxins often requires a greater volume of reagents than that required for PCR tests, which affects the thickness of the reaction wells and therefore the thickness of the analysis card, which must therefore be greater (the intensity of the fluorescence signal detected being directly proportional to the thickness of fluorescent liquid present in the reaction wells). This particular aspect poses problems as regards sealing of the plate in the base since sealing the faces of the plate between films of the base, as in the case of “FilmArray®”, does not ensure sealing at the edges of the plate, and there is therefore a risk of mixing of the biological samples, or other liquids.

There is therefore currently no manufacturing method making it possible to obtain an analysis card having a thick plate between two films of a base, for example in the context of endotoxin detection tests, which is rapid, easy to produce and inexpensive.

### SUMMARY

The invention therefore aims to manufacture an analysis card provided with a plate having a predetermined thickness capable of ensuring the separation of the fluid pathways extending in the analysis card, for example making it possible to analyze several dilutions of the same biological sample or different biological samples or different biological samples with several dilutions, in a more controlled manner, without the risk of mixing, more quickly, more easily and less expensively.

According to a first aspect, there is proposed a method for manufacturing a biological analysis card configured for the biological analysis of a biological sample, said method comprising:
a step a) of supplying a base made up of:
at least two superimposed films,
a reception space formed between the two films delimited by a first border and an opening,
ducts delimited by contours and opening into the reception space through the first border,
a step b) of placing a plate in the reception space by inserting the plate through the opening, the plate comprising:
a first face and a second face connected by a rim having a profile,
a plurality of wells opening onto at least the first face or the second face,
a plurality of channels fluidically connecting wells,
a welding step c) comprising welding the two films of the reception space to the plate,
   the method being characterized in that the welding step c) comprises welding a film to segments of the rim of the plate by applying a heating block to said film against said rim on the side of the first face, said heating block comprising a support and a heating element, a first part of the heating element protruding from the support at least during the application of the heating block, said first part of the heating element then having a profile complementary to at least one segment of the profile of the rim of the plate, such that during the application of the heating block, the film takes on the shape of the rim when said film is pressed by the first part of the heating element.

According to advantageous but non-limiting features, which may be implemented alone or in any combination:
the profile of a segment of the rim of the plate is a straight line which defines a salient angle between said segment of the rim of the plate and the second face which is less than or equal to 90° or a curve of which a tangent defines a salient angle between said segment of the rim of the plate and the second face which is less than or equal to 90°;
the rim segments to which the film is welded are separation surfaces located on the rim between the channels;
the first part of the heating element of the heating block comprises non-heating zones the width of which is greater than the width of the channels, such that, when the first part of the heating element is applied to the film against the rim segments, the non-heating zones face the channels and fragile valves;
each duct is equipped with at least one fragile valve positioned at one end of the duct;
step c) comprises welding by the heating block of a film from the segments of the rim of the plate to inter-duct borders separating the ducts;
step b) comprises a step of positioning the plate in the reception space until the mouths of the channels are opposite the mouths of the ducts;
step c) comprises a step of closing off the opening of the reception space by welding the two films to each other;
the plate comprises a vacuum port connected to channels, said channels being connected to wells and the method comprises a vacuum step following the welding step c), the vacuum step comprising piercing the film covering the vacuum port and plugging the channels connecting the vacuum port to the wells once the vacuum has been created;
the thickness of the plate is greater than 0.5 mm;
the welding of the two films of the reception space to the plate comprises welding a first film to the first face;
the heating block comprises a second part of the heating element the shape of which is complementary to the shape of the first face of the plate, the welding of the two films of the reception space to the plate comprises welding a first film to the first face, the first film being pressed onto the first face.

According to a second aspect, an analysis card manufactured by the method set out above is proposed.

According to a third aspect, a heating block configured to implement the method set out above is proposed, said heating block comprising a support and a heating element, a first part of the heating element being configured to protrude at least during the application of the heating block, said first part of the heating element then having a profile complementary to at least part of the profile of the rim of the plate.

This heating block is advantageously supplemented by the various features below, which may be implemented alone or in their various possible combinations:
the first part of the heating element comprises non-heating zones the width of which is greater than the width of the channels;
the non-heating zones of the first part of the heating element are recesses;
the first part of the heating element comprises flexible nichrome (NiCr) elements.

### DETAILED DESCRIPTION OF THE DRAWINGS

Other features, aims and advantages of the invention will become apparent from the following description, which is purely illustrative and non-limiting, and which must be read with reference to the appended drawings, in which:

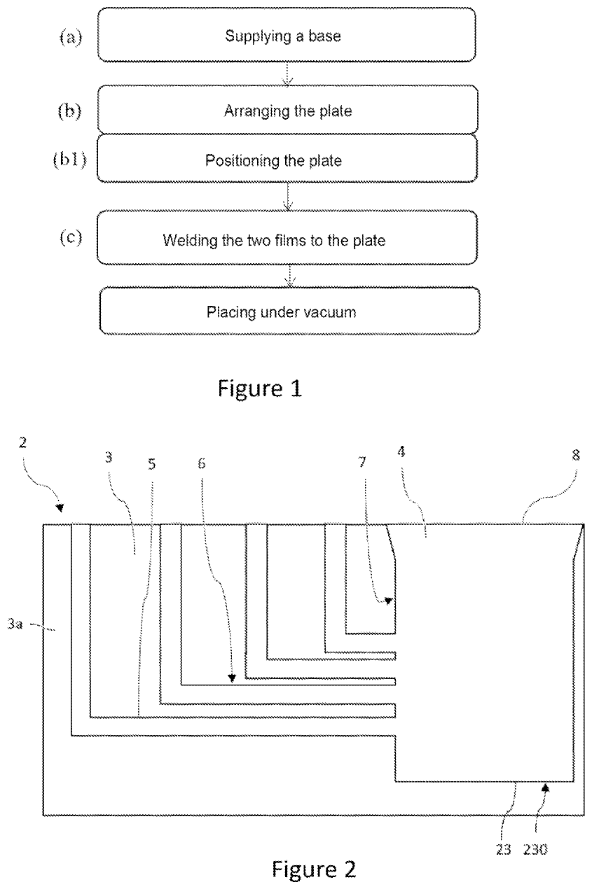

FIG. 1 is a diagram showing steps of the method for manufacturing the analysis card according to a possible embodiment of the invention;

FIG. 2 schematically depicts an example of a base of an analysis card according to a possible embodiment of the invention;

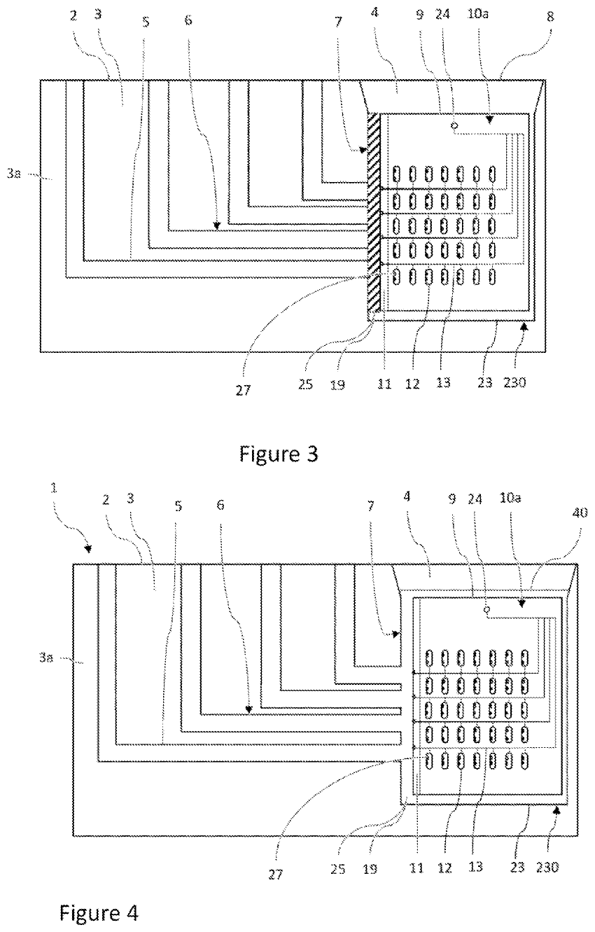

FIG. 3 shows an example of an analysis card during manufacture, according to a possible embodiment of the invention,

FIG. 4 schematically depicts an example of an analysis card according to a possible embodiment of the invention;

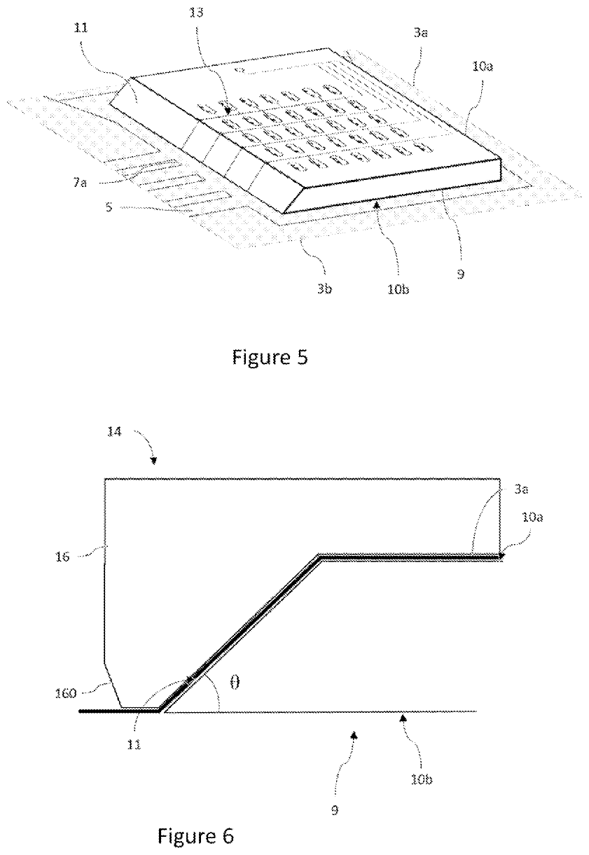

FIG. 5 is a perspective view of a part of an analysis card according to a possible embodiment of the invention;

FIG. 6 schematically shows the heating block pressing the first film against the rim of a plate of an analysis card having a profile forming a straight line according to a possible embodiment of the invention;

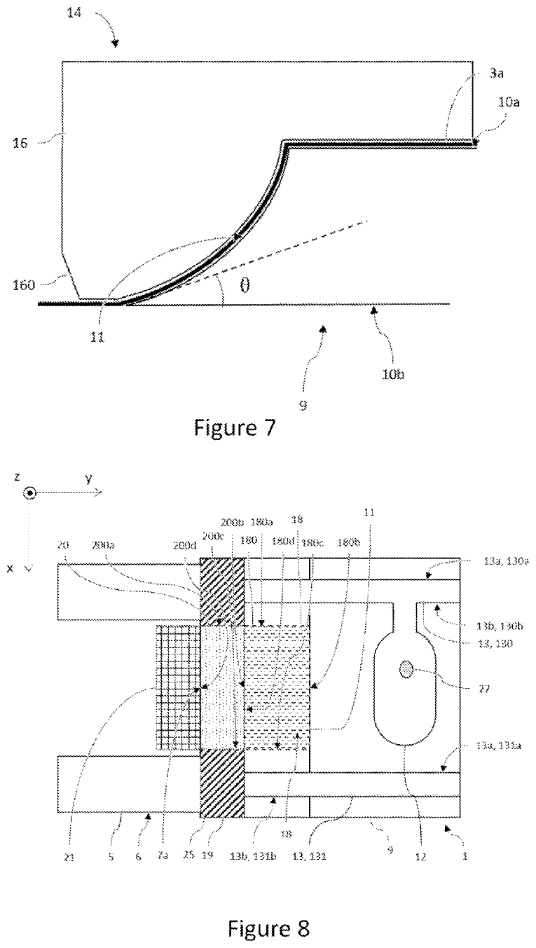

FIG. 7 schematically shows the heating block pressing the first film against the rim of a plate of an analysis card having a curved profile according to a possible embodiment of the invention;

FIG. 8 shows an enlarged view of the analysis card at a rim of the plate;

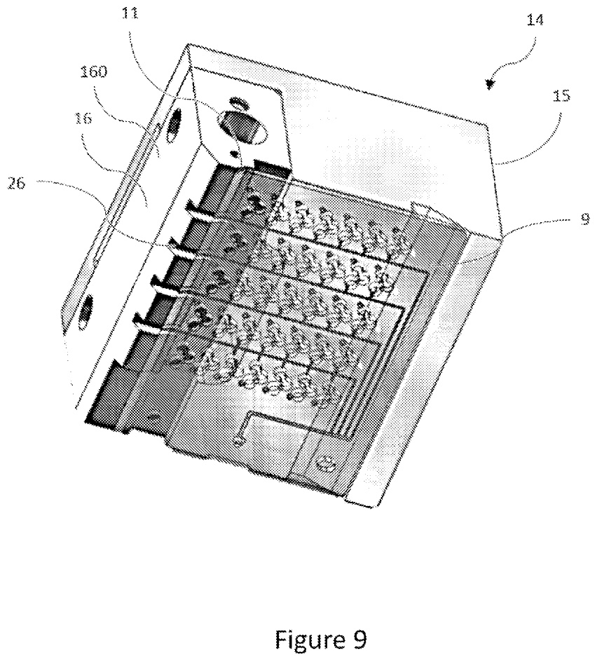

FIG. 9 depicts a heating block and a plate.

### DETAILED DESCRIPTION

The present invention relates to a method for manufacturing an analysis card 1 shown in FIG. 4. FIG. 1 provides details of the steps of the method, which first of all comprises a step a) of supplying a base 2. Referring to FIG. 2, the base 2 is formed of two superimposed thermoplastic films 3. The material constituting the films 3 may be a complex based on polypropylene or polyethylene, for example. The films 3 are thin, soft, flexible surfaces. “Thin” means that the thickness of the films 3 is less than 200 μm. Preferably, the films 3 have a rectangular shape. More preferably, the two films 3a, 3b have the same shape when superimposed. Thus, it is not possible to distinguish the two films 3a, 3b in FIG. 2 since one is on top of the other. The film 3b is referenced in FIG. 5. The two films 3 are thermoplastic, which means that when heated to a certain temperature threshold, the films 3 will soften, allowing them to undergo a mechanical deformation which becomes fixed when the films 3 cool. The temperature threshold from which the films 3 soften and can be deformed depends on the material constituting the films 3. The material constituting the films 3 is preferably a polymer such as polypropylene or polyethylene or a complex film based on polypropylene or polyethylene. Typically, the temperature threshold required to soften the films 3 is above 60° C.

A reception space 4 is formed between the two films 3. More specifically, the reception space 4 is included between two free film 3 portions. “Free” means that the films 3 are not welded to each other. In the plane of the base 2, the reception space 4 is delimited by a first border 7 and an opening 8. The first border 7 is an area in which the two films 3 are welded together. In the example shown in FIG. 2, the first border 7 forms a straight line parallel to the width of the films 3 and, along this straight line, the two films 3 are welded to each other. This welding may for example be performed using a laser which melts the films 3 along a precise path such that, along this path, the two films 3 become welded to each other. Other borders where the two films 3 are welded together may delimit the reception space 4.

The opening 8 corresponds to an area in which the films 3 are not welded together, and are left free up to their edges. The opening 8 makes the reception space 4 accessible from the outside. Preferably, the reception space 4 has the same shape as the plate it is intended to receive, typically rectangular.

The opening 8 may comprise one or more of the three different edge portions of the films 3 additional to the first border 7, and located on the right in FIG. 2. In this case, the opening 8 therefore comprises a film 3 edge portion parallel to the first border 7 and two film 3 edge portions perpendicular to the first border 7. Each of these edge portions of the films 3 is free and is not welded to an edge portion of another film 3. According to a preferred embodiment shown in FIG. 2, the first border 7 and a second border 230 of the base 2 form a pocket 23 such that the opening 8 is located on only one side of a film 3.

The base 2 further comprises ducts 5 formed between the two films 3 and delimited by contours 6. A duct 5 is like a tunnel formed between the two films 3 which allows the circulation of fluid such as a liquid biological sample. The contours 6 of the ducts 5 form curves along which the two films 3 are welded to each other, in the same way as the first border 7. Each duct 5 is delimited by two contours 6. The contours 6 of different ducts 5 are connected by inter-duct borders 7a, where the two films 3 are welded to each other. The inter-duct borders 7a form part of the first border 7. The base 2 may also comprise various elements such as reservoirs formed between the films of the base 2 and connected to the ducts 5. The ducts 5 may also each comprise one or more fragile valves plugging said ducts 5. For example, these fragile valves may be defined by an area (measuring a few millimeters or a few centimeters) where the films 3 are weakly welded, and are configured to rupture as a function of a pressure applied to said fragile valves. A fragile valve is preferably located close to the reception space 4, in other words at the end of a duct 5 which opens into the reception space 4. For example, the reservoirs, which may take the form of blisters, may contain biological samples. The reservoirs may be pressed until the pressure applied to the fragile valves present in the ducts 5 connected to the reservoirs reaches a certain pressure threshold required to rupture the fragile valves. Once the fragile valves have ruptured, the biological samples contained in the reservoirs flow in the ducts 5 as far as the reception space 4.

The manufacturing method then comprises a step b) of arranging a plate 9 in the base 2 so as to end up with a base 2 equipped with a plate 9 as shown in FIG. 3. A plate 9 is generally defined as an element with a flat surface and having a certain thickness, which is however very small compared to the dimensions of its flat surface. For example, the thickness is at least 10 times smaller than the widths and lengths of the faces. Preferably, the plate 9 has a thickness of greater than or equal to 0.5 mm. In the example shown, the plate 9 has a rectangular surface, but other shapes could be chosen.

Preferably, the plate 9 is formed from a thermoplastic material, at least on its surfaces. For example, the plate 9 may be made of materials such as PP, PE, PMMA, PC, PS, POM, ABS, COP. As shown schematically in FIG. 5, the plate 9 is composed of two faces 10a, 10b opposite one another and separated by a small thickness, i.e. the thickness is at least 10 times smaller than the widths and lengths of the faces 10a, 10b. The largest dimensions and the smallest dimensions of the faces 10a, 10b of the plate 9, in this case the lengths and widths of the faces 10a, 10b, are preferably greater than 2 cm and, also preferably, less than 10 cm, and, more preferably, less than 4 cm. The thickness of the plate 9 is preferably less than 5 mm, more preferably less than 3 mm, and the thickness of the plate 9 is preferably greater than 0.5 mm. The faces 10a, 10b are connected by sides, including a rim 11. In other words, the rim 11 corresponds to another face of the plate 9, different from the faces 10a and 10b, and having a small width, i.e. at least 10 times smaller than the widths and lengths of the faces 10a, 10b. The length of the rim 11 is therefore equal to a length or a width of the faces 10a, 10b of the plate 9. Preferably, the profile of the rim 11 is inclined relative to the faces 10a, 10b and is therefore not perpendicular to the faces 10a, 10b. Preferably, with reference to FIG. 6, the profile of the rim 11 is a straight line which defines a salient angle θ between the rim 11 of the plate 9 and the second face 10b which is less than 90°. In other words, the smaller of the two angles defined by the profile of the rim 11 between the rim 11 and the second face 10b, i.e. the angle which is less than 180°, is less than 90°. In other words, the rim 11 preferably forms a bevel. According to another embodiment shown in FIG. 7, the profile of the rim 11 is a curve of which a tangent defines a salient angle θ between the rim 11 of the plate 9 and the second face 10b which is less than 90°. A tangent is for example depicted in dotted lines in FIG. 7. In other words, the smaller of the two angles defined by the profile of the rim 11 between the rim 11 and the second face 10b, i.e. the angle which is less than 180°, is less than 90°. According to this embodiment, the profile of the rim 11 is preferably a convex curve.

The plate 9 comprises a plurality of wells 12 opening at least onto one face 10a, 10b of the plate 9. The wells 12 may also pass through the plate 9 from one face 10a to another face 10b. The wells 12 may contain reagents 27. For example, in the case of tests for detecting the presence of endotoxins, the wells 12 contain three different reagents 27, comprising a detection agent in a non-active state in the absence of endotoxin-free activation, an activation agent for activating the detection agent comprising an enzyme and a fluorogenic substrate, and a control reagent 27 adapted to control the functionality of the detection reagent 27. The wells 12 are connected by channels 13 configured to supply the wells 12 with a liquid biological sample or with another liquid such as a reference fluid used for example for control wells 12. The channels 13 are delimited by two edges 13a, 13b. Note that the edges 13a, 13b constitute the interface between the interior of a channel 13 and of the face 10a of the plate 9. The edges 13a, 13b extend opposite one another in the direction in which a channel 13 extends. It is specified that, in FIG. 3, the edges 13a, 13b cannot be distinguished from the channels 13, the channels 13 being very thin and being depicted using lines. The edges 13a, 13b are referenced in FIG. 8. The channels 13 are present both on the face 10a of the plate 9 and on the rim 11 of the plate 9. In other words, it can be stated that the channels 13 extend from the rim 11 to the face 10a or that the channels 13 extend from the face 10a to the rim 11.

The plate 9 is placed in the reception space 4 of the base 2. This space (or functional clearance) is necessary for easy insertion of the plate 9 into the base 2. More specifically, the plate 9 is inserted into the reception space 4 via the opening 8. The plate 9 is arranged such that the rim 11 of the plate 9 is arranged facing the first border 7 of the base 2. Preferably, with reference to FIG. 1, step b) of placing the plate 9 in the reception space 4 comprises a step b1) in which the mouths of the channels 13 of the plate 9 are positioned opposite the mouths of the ducts 5 of the base 2. Thus, each channel 13 opens out opposite the mouth of a duct 5 such that each channel 13 forms a fluid pathway with a duct 5. Consequently, the plate 9 is considered to be correctly positioned in the reception space 4 when the mouths of the channels 13 are centered on the mouths of the ducts 5 and the fluid pathways are thus formed. The fluidic connection between a channel 13 and a duct 5 is therefore preferably ensured at the rim 11 of the plate 9, which will make it possible to obtain an analysis card 1 that is less bulky and easier to package. The plate 9 may be inserted automatically into the receiving space 4 using a clamp that grips the plate 9 and inserts the plate 9 into the receiving space, the gripping areas of the clamp going into the receiving space 4. As explained above, according to a preferred embodiment, the first border 7 and the second border 230 form a pocket 23 in the base 2. “Pocket” means a reception space the borders 7, 230 of which are longer than the opening, and more specifically a container open on only one side of the base 2 and formed by the films 3 and delimited by the first border 7 and the second border 230. The arrangement of the plate 9 therefore comprises the insertion of the plate 9 into the pocket 23. Preferably, the fit of the pocket 23 is such that the plate 9 cannot turn over or change orientation if the base 2 equipped with the plate 9 is moved around. In other words, except along the opening 8, the first border 7 and the second border 230 surround the plate 9 such that, when the plate 9 is arranged in the reception space 4, very little reception space 4 is left empty.

Next comes a welding step c) comprising welding the two films 3 of the reception space 4 to the plate 9. Preferably, step c) comprises welding the films 3 to the faces 10 of the plate 9. The two films 3 are therefore welded in the region of the reception space 4 to the faces 10a, 10b of the plate 9. In other words, a first film 3a is welded to the face 10a and a second film 3b is welded to the face 10b. This welding may be performed using heating objects which melt the films 3 on the plate 9. The films 3 are thus welded to the faces 10a, 10b of the plate 9. For example, a heating object may have a face with dimensions at least equal to the dimensions of one of the faces 10a, 10b. When pressed against a face 10a or 10b, the face of the heating object melts the film 3a, 3b arranged on the face 10a or 10b and the film 3a, 3b becomes welded to the face 10a or 10b. On completion of this welding, it will be appreciated that the plate 9 is fixed relative to the base 2. The plate 9 may no longer move within the reception space 4.

Advantageously, the welding of the film 3a to the face 10a and the welding of the film 3b to the face 10b are carried out simultaneously. This allows the method to be improved in various respects. First, the welding step is performed more quickly. Second, the plate 9 arranged in the base 2 is placed in the welding machine only once. If step c) comprises two steps of welding the films 3 to the faces 10 of the plate 9 (one for the first film 3a and one for the second film 3b), the plate 9 and the base 2 have to be turned over once one film 3 has been welded to one face 10 in order to weld the other film 3 to the other face 10. Placing the plate 9 and the base 2 in the welding machine only once makes it possible to speed up the method and limit potential positioning errors. Third, the welding will be more homogeneous since the plate 9 and the base 2 are positioned in exactly the same way for welding of the film 3a to the face 10a and welding of the film 3b to the face 10b (since these two welds are performed at the same time). To weld the two films 3 on the faces 10 of the plate 9 simultaneously, two heating objects are applied simultaneously, a first heating object being applied to the first film 3a and the first face 10a and a second heating object being applied to the second film 3b and the second face 10b. According to a certain embodiment, the heating objects are made of nichrome and they are not heated before being applied to the films 3a, 3b and the faces 10a, 10b. In use, these nichrome heating objects are first pressed on the films 3a, 3b and the faces 10a, 10b and then a current pulse is sent to the nichrome heating objects which induces rapid heating of the nichrome heating objects.

According to another embodiment, the welding of the film 3a to the face 10a and the welding of the film 3b to the face 10b are carried out successively.

The welding step c) comprises welding the first film 3a to rim 11 segments of the plate 9 by applying a heating block 14 to said first film 3a against said rim 11 on the side of the first face 10a. Welding of the first film 3a to rim 11 segments of the plate is preferably carried out simultaneously with or after welding of the first film 3a on the faces 10 of the plate 9.

If the films 3 were welded only to the faces 10 of the plate 9, the rim 11 of the plate 9 would remain free, i.e. no film 3 would be welded to the rim 11. As a result, the biological samples circulating in the channels 13 would be able to mix with one another at the rim 11, each biological sample being able to exit its channel 13 and circulate to another channel 13. As explained above, such mixing of different biological samples prior to their reaching the reaction wells 12 cannot be countenanced if it is desired to obtain valid and usable reaction results. For example, in the case of endotoxin detection tests, a biological sample must be analyzed at different concentrations. These fluids must not mix before reaching their respective wells 12, otherwise the results of the reactions will be unusable. Therefore, it is necessary to weld a film 3 to segments of the rim 11 in such a way as to enhance the attachment of the plate 9 to the base 2 and isolate the channels 13.

Preferably, the rim 11 segments to which the film 3a is welded are separation surfaces 18 located on the rim 11 between the channels 13 as shown in FIG. 8. A separation surface 18 is shown in FIG. 8 as a surface filled with dashes. At the rim 11, the channels 13 are therefore separated by the separation surfaces 18. It will thus be appreciated here that the separation surfaces 18 are rim 11 segments and therefore parts of the plate 9. The separation surfaces 18 have any shape and are delimited by at least one second side 180. Preferably, the separation surfaces 18 have a rectangular shape and are therefore delimited by four sides 180a-180d. A separation surface 18 may extend lengthwise, in the direction x shown in FIG. 8, on the rim 11, from an edge 13a, 13b of a first channel 13 to an edge 13b, 13a of a second channel 13, the second channel 13 being consecutive to the first channel 13. Preferably, the separation surfaces 18 are not in contact with a channel 13 and are thus located between a first boundary fixed at a first distance from an edge 13a, 13b of a first channel 13 and a second boundary fixed at a second distance from an edge 13b, 13a of a second channel 13. In other words, there are virtual margins around the channels 13 which the separation surfaces 18 do not breach. As shown in FIG. 8, the sides 180a and 180c are not in contact with the edges 130b, 131a of the channels 130, 131. It is reiterated that, preferably, the separation surfaces 18 are rectangular and thus, more preferably, as shown in FIG. 8, the sides 180a and 180c are parallel to the edges 130b, 131a of the channels 130, 131. More specifically, as shown schematically, the side 180a is located on a virtual margin of the edge 130b and the side 180c is located on a virtual margin of the edge 131a. As regards the direction y shown in FIG. 8, the separation surfaces 18 do not extend beyond the rim 11. The separation surfaces 18 therefore do not extend either as far as the face 10a of the plate 9, or as far as the face 10b of the plate 9. In other words, the sides 180b and 180d are thus located between the interface of the rim 11 with the face 10a and the interface of the rim 11 with the face 10b. Preferably, the sides 180b and 180d are parallel to the interface of the rim 11 with the face 10a and the interface of the rim 11 with the face 10b. More preferably, the side 180b coincides with the interface of the rim 11 with the face 10a and the side 180d coincides with the interface of the rim 11 with the face 10b.

The welding of a film 3 to the rim 11 segments is performed using a heating block 14 shown in FIG. 9. The heating block 14 comprises a support 15 and a heating element 16. The heating element 16 is brought to a heating temperature suitable for at least partially melting a film 3, for example at least 60° C. The support 15 and the heating element 16 may be two independent components connected to one another. For example, the support 15 and the heating element 16 may be adhesively bonded or welded. The heating element 16 is made of a material that conducts heat, and is typically made of metal. The heating element 16 comprises a first part 160 which protrudes along the rim 11, substantially from one face 10a to the other face 10b, at least during the application of the heating block 14 to the rim 11. In the example shown, the first part 160 protrudes from the support 15 in such a way as to form a ledge from the support 15.

The first part of the heating element 160 has a profile complementary to at least part of the profile of the rim 11 of the plate 9. Therefore, the first part of the heating element 160 matches the shape of segments of the rim 11. If the rim 11 has a bevel shape, the first part of the heating element 160 then has a shape complementary to parts of this bevel such that segments of the rim 11 may fit against the first part of the heating element 160. Thus, when the heating block 14 is applied to the film 3a arranged on the rim 11 of the plate 9, the film 3a melts owing to the heat from the heating element 16, and becomes welded to the rim 11 segments with respect to which the first part of the heating element 160 has a complementary profile. Preferably, the profile of the first part of the heating element 160 is complementary to the separation surfaces 18 of the rim 11. In other words, the heating block 14 comprises non-heating zones 26 the width of which is greater than the width of the channels 13. The non-heating zones 26 may be recesses 26 in the first part of the heating element 16. These recesses 26 may, for example, take the form of grooves. The non-heating zones 26 may also be portions made of an insulating material, which does not conduct heat, in the first part of the heating element 160. When the heating element 16 is applied to the rim 11 of the plate 9, the non-heating zones 26 are positioned at the channels 13 such that no portion of the heating element 16 is applied directly to the channels 13. As a result, the heating element 16 does not weld the film 3a to the channels 13 but welds the film 3a to the separation surfaces 18 and therefore only between the channels 13 of the rim 11. This makes it possible to specifically isolate the channels 13 from one another and to prevent the circulation of a biological sample between the various channels 13 at the rim 11.

As in the embodiment shown, the heating element may be rigid, in which case the first part of the heating element 160 protrudes permanently and always has a profile complementary to the profile of the rim 11. It is also possible for the heating element 16 to be flexible, and therefore for the protrusion of the first part of the heating element 160 to be caused by the application of said heating element 16 against the rim 11. For example, the first part of the heating element 160 may comprise strips or a bundle of metal wires, for example made of nichrome (NiCr). The flexibility of the heating element 16 allows self-adjustment to compensate for any small geometric differences, for example generated during the method for manufacturing the plate 9 by injection molding.

According to a preferred embodiment, the welding of a film 3 to segments of the rim 11 of the plate 9 extends at least as far as the inter-duct borders 7a separating the ducts 5. It will therefore be appreciated that the welding of the film 3 thus extends continuously from the rim 11 segments at least to the inter-duct borders 7a. In other words, step c) comprises welding the film 3a to transitional sub-zones 20 of a transitional zone 19 of the film 3b delimiting a transitional space 25. With reference to FIG. 3, once the plate 9 is fixed in the base 2, a transitional space 25 is formed between the rim 11 and the first border 7. The transitional space 25 is defined between a portion of the film 3a and a portion of the film 3b, the portion of the film 3b being the transitional zone 19. The transitional zone 19 is therefore a portion of the film 3b that is not welded to the film 3a or to the plate 9, between the rim 11 and the first border 7. In FIG. 3, the transitional zone 19 is the striped surface. The transitional zone 19 comprises transitional sub-zones 20 located in the extension of the separation surfaces 18 and extending as far as the inter-duct borders 7a. FIG. 8 shows an enlarged view of FIG. 3. A transitional sub-zone 20 is shown in FIG. 8 and is the dotted surface within the transitional zone 19 which is itself striped in FIG. 8. The transitional sub-zones 20 are not located opposite mouths of channels 13 or ducts 5 in the transitional zone 19. On the contrary, the transitional sub-zones 20 are located between the fluid pathways. As a reminder, a fluid pathway is formed by a channel 13 and a duct 5 that open out opposite one another. Each fluid pathway therefore comprises a channel 13, a duct 5 and a transitional zone 19 portion so that the biological sample circulating in the duct 5 can reach the channel 13 via this transitional zone 19 portion.

Note that the transitional space 25 is a part of the reception space 4, located between the rim 11 of the plate 9 and the first border 7 of the base 2. This transitional space 25 poses a problem for the analysis of different biological samples. It is not desired to leave the transitional space 25 free since this allows the mixing of different biological samples circulating from the ducts 5 of the base 2 to the channels 13 of the plate 9. It must be understood that, even if the plate 9 is arranged in such a way as to minimize the surface area of the transitional zone 19 and therefore the volume of the transitional space 25 before the films 3 are welded to the faces 10a, 10b, i.e. before the interface between the rim 11 and the face 10b of the plate 9 is joined to the first border 7, the transitional zones 19 and the transitional space 25 will still exist. This is because, first of all, the films 3 are flexible and the transitional zone 19 and the transitional space 25, however narrow they may be, remain if the films 3 are welded only to the faces of the plate 9. It is also explained by the fact that, when the films 3 are welded to the faces 10a, 10b, there is no guarantee that the plate 9 will not move, however slightly, within the reception space 4. Therefore, it is preferable to weld the transitional sub-zones 20 of the film 3b to the film 3a. It will thus be appreciated that the film 3a will be welded to the transitional sub-zones 20, and therefore that the films 3a and 3b will be welded to each other between the fluid pathways, to allow the circulation of a biological sample between the duct 5 and the channel 13 of each fluid pathway 26 while preventing the circulation of a biological sample between the ducts 5 and the channels 13 of different fluid pathways 26. Thus, welding the films 3a and 3b together as far as the inter-duct borders 7a makes it possible to enhance the isolation of the various fluid pathways such that the biological samples circulating from the ducts 5 to the channels 13 do not mix in the transitional zone 19. In this preferred embodiment, the first part of the heating element 160 has a profile with a shape complementary both to rim 11 segments of the plate 9 and to portions of the base 2 in the transitional sub-zones 20.

More preferably, the welds of the films 3 extend beyond the inter-duct borders 7a. In other words, the welding step c) comprises welding a film 3 to the plate 9 from the rim 11 segments of the plate 9 to beyond the inter-duct borders 7a separating the ducts 5. This therefore means that the films 3a and 3b are welded to each other between the ducts 5 as shown in FIG. 8 in the zone 21 of the film 3b depicted schematically using a grid pattern. Extending the welding to beyond the inter-duct borders 7a makes it possible to ensure that the films 3a and 3b are fully welded to each other from the rim 11 segments to the inter-duct borders 7a. In this preferred embodiment, the first part of the heating element 160 has a profile with a shape complementary both to rim 11 portions of the plate 9 and to portions of the base 2 in the transitional sub-zones 20, to beyond the inter-duct borders 7a. Preferably, the ducts 5 are not heated so as to avoid rupturing the fragile valves.

Advantageously, the step of welding the film 3a to the face 10a of the plate 9 and the step of welding a film 3 to rim 11 segments of the plate 9 are performed simultaneously using the same heating block. In this case, the heating element 16 of the heating block 14 comprises a second part with a shape complementary to the shape of a face 10 of the plate 9. Accordingly, when the heating element 16 of the heating block 14 is applied to the film 3a which covers the face 10a of the plate 9, the second part of the heating element matches the shape of the face 10a of the plate 9 and welds the film 3a to the face 10a while the first part of the heating element 160 welds the film 3a to rim 11 segments of the plate 9. Welding the film 3a to the face 10a at the same time as the film 3a is welded to rim 11 segments has several advantages. First, it speeds up the method, since the steps are performed at the same time and not separately. It also reduces the number of rejects since problems with the operation of the machine and positioning of the plate 9 and the base 2 in the machine are less likely to occur in one step than in two steps. Furthermore, fewer tools are required since there is no need for a dedicated tool for welding the film 3a to the face 10a and a dedicated tool for welding the film 3a to rim 11 segments, there is only the heating block 14, which reduces costs. Lastly, the plate 9 is thus heated only once, which reduces the risk of deterioration of heat-sensitive reagents 27 already present in the wells 12.

More preferably, the welding of the first film 3a to the first face 10a, the welding of the second film 3b to the second face 10b and the welding of the first film 3a to rim 11 segments are carried out simultaneously. It will therefore be appreciated that the welding of the first film 3a to the first face 10a and the welding of the first film 3a to rim 11 segments are performed using a single heating block 14. The welding of the second film 3b to the second face 10b may be performed using another heating object. The heating block 14 is applied to the first film 10a at the same time as a heating object is applied to the second film 10b. According to this embodiment, the method is thus even faster.

According to another embodiment, in particular in the case where the plate 9 has a small thickness (i.e. less than 0.5 mm), the profile of the rim 11 of the plate 9 is not inclined relative to the faces 10a, 10b and may be perpendicular to the faces 10a, 10b. In this case, the film(s) 3a, 3b are welded at the rim 11 by rivet heading.

Preferably, the method comprises a step of closing off the reception space 4 such that the reception space 4 is no longer open to the outside via the opening 8. The closing step is implemented by welding the two films 3 together. Welding may be performed for example using a laser or by applying a heating object to the films 3. FIG. 4, which depicts an analysis card 1 obtained at the end of the present method, shows the weld line 40 closing off the reception space 4 of the pocket 23. Closing off the reception space 4 first of all ensures that the plate 9 does not come out of the reception space 4 and therefore remains inside the reception space 4. This also helps to isolate the plate 9 and prevent it from being damaged. It also protects the plate 9 from the outside, thereby preventing any foreign particles or foreign bodies from getting into the wells 12 of the plate 9 which would compromise the validity of the reactions in the wells 12 upon arrival of biological samples. Preferably, the weld of the two films 3 which closes off the reception space 4 closely surrounds the plate 9 so that the plate 9 is securely held and immobilized inside the base 2. Thus, preferably, in FIG. 3, the weld which closes off the opening 8 runs along the sides of the plate 9 and, more preferably, the distance separating the weld which closes off the opening 8 and the plate 9 is less than 5 mm, and more preferably less than 2 mm.

The method for manufacturing the analysis card 1 preferably comprises a step of placing the plate 9 under vacuum. The step of placing the plate 9 under vacuum aims to create a vacuum in the wells 12 and the channels 13 of the plate 9. As a vacuum is created in the plate 9, any biological sample introduced into the ducts 5 of the base 2 will be sucked into the channels 13 then into the wells 12 of the plate 9. The reactions between the biological sample and the reagents 28 in the wells 12 will thus take place. Furthermore, a vacuum step may be implemented prior to the step of welding the films 3 to the faces 10 of the plate 9. Thus, when the films 3 are welded to the faces 10 of the plate 9, there are no air bubbles between the films 3 and the faces 10.

To carry out this vacuum step, with reference to FIG. 4, the plate 9 supplied advantageously has a vacuum port 24. The vacuum port 24 is connected to the channels 13 of the plate 9. Preferably, the vacuum port 24 opens onto at least one face 10a of the plate 9. A vacuum member, such as a suction cup, adheres to the vacuum port and creates a vacuum in the channels 13 and the wells 12 of the plate 9. The operation may last between 15 seconds and 2 minutes, usually 30 seconds. Next, a heating member is applied to the channels 13 connected to the vacuum port 24 to melt the plate 9 at the channels 13 and plug the channels 13. The vacuum is therefore captured in the wells 12 and channels 13 of the plate 9.

According to the embodiment in which the films 3 are already welded to the faces 10 when the vacuum is created, the vacuum step comprises piercing the film 3 covering the vacuum port 24. To be specific, it is essential to access the vacuum port 24 to suck out the air and create a vacuum within the plate 9. Moreover, it is preferable that the ducts 5 not be open to the outside so that the vacuum is effective. Thus, for example, the ducts 5 may comprise fragile valves which close off the ducts 5 at least during the vacuum step.

The invention is not limited to the embodiment described and shown in the appended figures. Modifications are possible, in particular from the point of view of the nature of the various technical features or of substitution of technical equivalents, without however departing from the scope of protection of the invention.

1. A method for manufacturing a biological analysis card (1) configured for the biological analysis of a biological sample, said method comprising:
a step a) of supplying a base (2) made up of:
at least two superimposed films (3),
a reception space (4) formed between the two films (3) delimited by a first border (7) and an opening (8),
ducts (5) delimited by contours (6) and opening into the reception space (4) through the first border (7),
a step b) of placing a plate (9) in the reception space (4) by inserting the plate (9) through the opening (8), the plate (9) comprising:
a first face (10a) and a second face (10b) connected by a rim (11) having a profile,
a plurality of wells (12) opening onto at least the first face (10a) or the second face (10b),
a plurality of channels (13) fluidically connecting wells (12),
a welding step c) comprising welding the two films (3) of the reception space (4) to the plate (9),
the method being characterized in that the welding step c) comprises welding a film (3) to segments of the rim (11) of the plate (9) by applying a heating block (14) to said film (3) against said rim (11) on the side of the first face (10a), said heating block (14) comprising a support (15) and a heating element (16), a first part of the heating element (160) protruding from the support (15) at least during the application of the heating block (14), said first part of the heating element (160) then having a profile complementary to at least one segment of the profile of the rim (11) of the plate (9), such that during the application of the heating block (14), the film (3) takes on the shape of the rim (11) when said film (3) is pressed by the first part of the heating element (160).

2. The method for manufacturing an analysis card (1) according to claim 1, wherein the profile of a segment of the rim (11) of the plate (9) is a straight line which defines a salient angle (θ) between said segment of the rim (11) of the plate (9) and the second face (10b) which is less than or equal to 90° or a curve of which a tangent defines a salient angle (θ) between said segment of the rim (11) of the plate (9) and the second face (10b) which is less than or equal to 90° .

3. The method for manufacturing an analysis card (1) according to claim 1, wherein the rim (11) segments to which the film (3) is welded are separation surfaces (18) located on the rim (11) between the channels (13).

4. The method for manufacturing an analysis card (1) according to claim 1, wherein the first part of the heating element (160) of the heating block (14) comprises non-heating zones (26) the width of which is greater than the width of the channels (13), such that, when the first part of the heating element (160) is applied to the film (3) against the rim (11) segments, the non-heating zones (26) face the channels (13) and fragile valves.

5. The method for manufacturing an analysis card (1) according to claim 1, wherein step c) comprises welding by the heating block (14) of a film (3) from the segments of the rim (11) of the plate (9) to inter-duct borders (7a) separating the ducts (5).

6. The method for manufacturing an analysis card (1) according to claim 1, wherein step b) comprises a step of positioning the plate (9) in the reception space (4) until the mouths of the channels (13) are opposite the mouths of the ducts (5).

7. The method for manufacturing an analysis card (1) according to claim 1, wherein step c) comprises a step of closing off the opening (8) of the reception space (4) by welding the two films (3) to each other.

8. The method for manufacturing an analysis card (1) according to claim 1, wherein the plate (9) comprises a vacuum port (24) connected to channels (13), said channels (13) being connected to wells (12) and wherein the method comprises a vacuum step following the welding step c), the vacuum step comprising piercing the film (3) covering the vacuum port (24) and plugging the channels (13) connecting the vacuum port (24) to the wells (12) once the vacuum has been created.

9. The method for manufacturing an analysis card (1) according to claim 1, wherein the thickness of the plate (9) is greater than 0.5 mm.

10. The method for manufacturing an analysis card (1) according to claim 1, wherein the welding of the two films (3) of the reception space (4) to the plate (9) comprises welding a first film (3a) to the first face (10a).

11. The method for manufacturing an analysis card (1) according to claim 1, wherein the heating block comprises a second part of the heating element the shape of which is complementary to the shape of the first face (10a) of the plate (9), the welding of the two films (3) of the reception space (4) to the plate (9) comprises welding a first film (3a) to the first face (10a), the first film (3a) being pressed onto the first face (10a).

12. An analysis card (1) manufactured by the method according to claim 1.

13. A heating block (14) configured to implement the method according to claim 1, said heating block (14) comprising a support (15) and a heating element (16), a first part of the heating element (160) being configured to protrude at least during the application of the heating block (14), said first part of the heating element (160) then having a profile complementary to at least part of the profile of the rim (11) of the plate (9).

14. The heating block (14) according to claim 13, wherein the first part of the heating element (160) comprises non-heating zones (26) the width of which is greater than the width of the channels (13).

15. The heating block (14) according to claim 13, wherein the non-heating zones (26) of the first part of the heating element (160) are recesses (26).

16. The heating block (14) according to claim 13, wherein the first part of the heating element (160) comprises flexible nichrome (NiCr) elements.
